(19) United States
(12) Patent Application Publication
(10) Pub. No.: US 2022/0180740 A1
(43) Pub. Date: Jun. 9, 2022

(54) CAMERA PARKING ENFORCEMENT

(71) Applicant: Clancy Systems, Inc., Denver, CO (US)

(72) Inventors: Lawrence Berman, Delray Beach, FL (US); Stanley J. Wolfson, Denver, CO (US)

(21) Appl. No.: 17/247,201

(22) Filed: Dec. 3, 2020

(51) Int. Cl. G08G 1/017; G08G 1/04; G07B 15/02; G06K 9/00

(52) U.S. Cl. CPC G08G 1/0175; G08G 1/04; G06K 2209/23; G06K 9/00785; G06K 2209/15; G07B 15/02

(57) ABSTRACT

An example system for camera parking enforcement includes an intelligent network of cameras, and an enforcement computing device. The enforcement computing device determines a lot time based on the vehicle being in the designated parking area, and compares the lot time to a payment confirmed by a payment processor. The enforcement computing device issues a notice of violation for the vehicle when the vehicle remains in the designated parking area for longer than an allowed time based on the payment confirmed by the payment processor.

### CROSS REFERENCE TO RELATED APPLICATIONS

This application is related to U.S. patent application Ser. No. 16/881,739 filed May 22, 2020 for “Payment And Enforcement System For Electric Vehicle Charging Stations” of Berman and Wolfson, which is a continuation-in-part (CIP) of U.S. patent application Ser. No. 15/416,367 filed Jan. 26, 2017, which is a continuation-in-part (CIP) of U.S. patent application Ser. No. 14/709,001 filed May 11, 2015 which claims the priority benefit of U.S. Provisional Patent Application No. 61/992,260 filed on May 13, 2014; and this application is a continuation-in-part (CIP) of U.S. patent application Ser. No. 15/099,465 filed Apr. 14, 2016 which is a continuation-in-part (CIP) of U.S. patent application Ser. No. 14/709,001 filed May 11, 2015 which claims the priority benefit of U.S. Provisional Patent Application No. 61/992,260 filed on May 13, 2014; and this application is a continuation-in-part (CIP) of U.S. patent application Ser. No. 15/099,508 filed Apr. 14, 2016 which is a continuation-in-part (CIP) of U.S. patent application Ser. No. 14/709,001 filed May 11, 2015 which claims the priority benefit of U.S. Provisional Patent Application No. 61/992,260 filed on May 13, 2014; all of these applications hereby incorporated by reference for all that is disclosed as though fully set forth herein.

This application is also related to U.S. Provisional Patent Application No. 61/951,875 titled “Secure payment system” of Stanley J. Wolfson, filed on Mar. 12, 2014 and corresponding U.S. patent application Ser. No. 14/645,196 filed on Mar. 11, 2015, and U.S. patent application Ser. No. 14/671,456 titled “Parking Meter Payment Device” of Berman, et al. filed on Mar. 27, 2015, each of which is hereby incorporated by reference for all that is disclosed as though fully set forth herein.

### BACKGROUND

Parking and Electric Vehicles (EV) charging stations may lack an attendant. Even if an attendant is available, self-serve is often faster and preferred. While most people will pay the required fees, for others, parking enforcement will be necessary.

### BRIEF DESCRIPTION OF THE DRAWINGS

FIG. 1 shows an example system for camera parking enforcement.

FIG. 2 illustrates example camera parking enforcement.

FIG. 3 shows an example user interface for example camera parking enforcement.

FIG. 4 is an example user interface to review/filter violations for camera parking enforcement.

FIG. 5 is an example user interface to generate violations for camera parking enforcement.

FIG. 6 is a flow diagram illustrating example camera parking enforcement.

### DETAILED DESCRIPTION

The systems and methods disclosed herein not only creates a robust enforcement system, but also enables that equipment to pay for itself by charging the vehicle owner for parking and/or charging their vehicle.

In an example, signs may indicate the days of the week and time that parking and/or EV vehicle charging is permitted. The sign may also indicate the duration of time permitted to park and charge a vehicle. The back-end software can be programmed to not permit piggyback parking (e.g., two sessions of parking, one after the other). By way of illustration, if a vehicle parks for 2 hours (as indicated by the sign) and then 5 minutes later after the 2 hours have expired and the user tries to park again, the user may be automatically denied further charging/parking privileges in the same spot, lot, or enforcement area. Cars that park in that space that are not totally electric can also be issued a violation automatically.

In an example, secure electronic payment may be implemented to pay for use of a parking area and/or EV charging device using an electronic device such as, but not limited to, a mobile phone, without needing to have a physical credit card or traditional cash on hand. In an example, the user may execute a payment application on their mobile device to pay for parking and/or EV charging and the parking fee at the same device. In another example, users may prepay (e.g., monthly, or as part of an event ticket), and that payment can be confirmed when the vehicle enters/exits a designated parking area.

In an example, the payment duration can be configured so that over-payment and duration can be monitored and adjusted. So, for example, if a user wanted to charge their vehicle for one hour, but remain parked longer, this could be paid/configured by the user via the mobile device app. Then if the vehicle was still in the space after the parking time expired, a parking violation could be issued.

In use, a mobile computing device (e.g., mobile phone) may include an installed application or “app”. When the mobile computing device is activated via the app, it searches for any parking and/or EV charging devices in the area which may be operated with the digital payment. In an example, the app may display a list of such charging devices and/or parking areas in the user's vicinity which accept payment via the secure payment and enforcement. In other examples, the customer may manually identify the parking and/or EV charging device (e.g., by entering a device ID in the app).

It is noted that the driver does not need to establish a connection to a payment provider or other entity at the parking area. As such, the parking and/or EV charging device does not need to be configured with an expensive to install and maintain modem or other communications system. This enables a “hands-free” approach to parking, by paying in advance.

Of course, the secure payment and enforcement may be implemented with any EV charging devices and/or other parking facilities. The examples described herein are merely illustrative, and other applications will also become apparent to those having ordinary skill in the art after becoming familiar with the teachings herein. The parking enforcement may be used in an attended and/or unattended environment.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the examples described herein are provided for purposes of illustration, and are not intended to be limiting. Other devices and/or device configurations may be utilized to carry out the operations described herein.

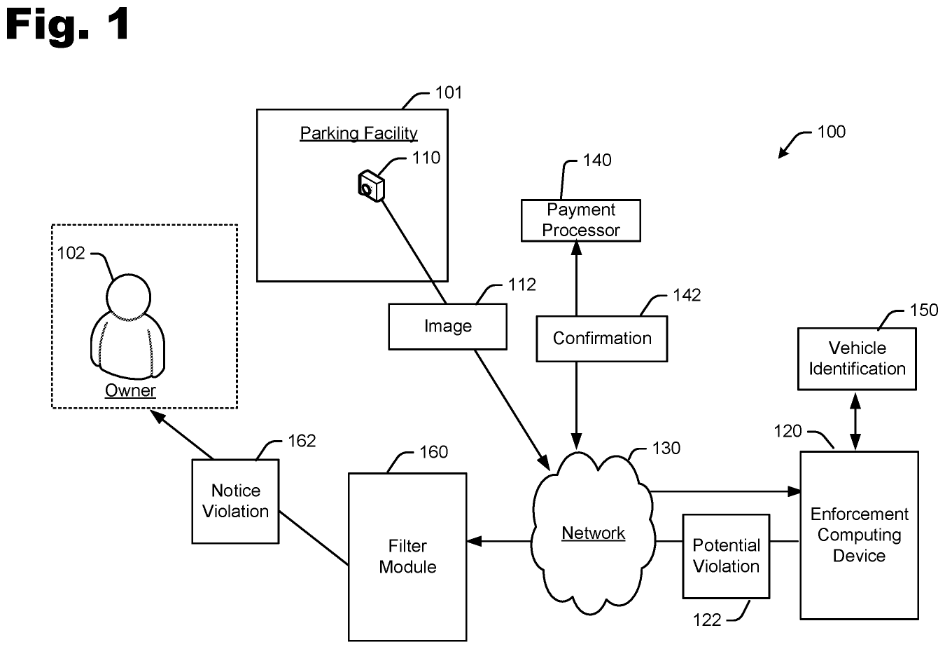

FIG. 1 shows an example system for camera parking enforcement. System 100 may be implemented with any of a wide variety of computing devices. Each of the computing devices may include memory, storage, and a degree of data processing capability at least sufficient to manage a communications connection either directly with one another or indirectly (e.g., via a network). At least one of the computing devices is also configured with sufficient processing capability to execute program code and/or other logic described herein.

In an example, camera parking enforcement may be implemented for a parking facility 101 having a network of intelligent cameras 110. The cameras 110 may be installed as part of the system, or the system 100 may implement already installed cameras. An enforcement computing device 120 may receive communications from the network of intelligent cameras 110. The enforcement computing device 120 may be any suitable computer or computing device (e.g., server computer, cloud computing system, desktop or laptop computer) capable of accessing a network 130.

In an example, the enforcement computing device 120 may operate with a payment processor 140 to confirm payment. For example, the user may have already provided payment information (e.g., credit card or bank account information) to a third-party payment processor, who is a trusted payment processor such as the user's bank, credit card issuer, direct carrier billing (e.g., billing to a cell phone account), digital currency, or other payment service, and therefore the user does not have to provide any payment information to the token handler or the token provider. As such, the systems and methods disclosed herein reduce the opportunity for fraud, while providing the user with the convenience of a so-called “cashless” transaction. Likewise, the owner of the parking and/or EV charging facility receives payment from a trusted third-party payment processor without risk that the payment form (e.g., credit card) is stolen or unauthorized.

The payment processor 140 may support simple linear and/or complex dynamic rate structures. For example, the unit may charge higher prices during peak hours or overall electricity usage conditions (higher mid-day when air conditioning units are also running, and less at night when demand is lower). Tiered parking may also be available, including but not limited to, higher rates for preferred or premium parking (e.g., near the building, in the shade, etc.), monthly payments, package pricing (e.g., residents, members, ticket-holder pricing), and discounted parking (e.g., for disabled or military veterans). In an example, the enforcement mechanisms (e.g., parking zones, pricing, timer buffers, etc.) can be pre-programmed or configured and reconfigured (e.g., based on the event) for these types of changes to the rate that is charged. Indeed, even free parking and/or charging may be offered.

The enforcement may also enable the user to extend parking and/or charging without having to go back to the parking and/or EV charging device or attendant. The time left is shown on the user's mobile phone. A warning message may be delivered to the user alerting the user that their paid for parking and/or charging time is ending so that additional payment can be made.

camera parking enforcement may be implemented with any of a wide variety of computing devices. Each of the computing devices may include memory, storage, and a degree of data processing capability at least sufficient to manage a communications connection either directly with one another or indirectly (e.g., via a network). At least one of the computing devices is also configured with sufficient processing capability to execute program code and/or other logic described herein.

camera parking enforcement may be implemented with one or more communication network 130, such as a local area network (LAN) and/or wide area network (WAN) and/or other communications platform such as a mobile communications network. In an example, the network includes the Internet and/or other mobile communications network (e.g., a 3G or 4G mobile device network).

In an example implementation, the network of intelligent cameras 110 issues one or more image 112. For example, an image of a vehicle (or portion of the vehicle and/or license plate or other identifier) may be issued when the vehicle enters and/or leaves a parking area and/or an area or “zone” within a larger parking area. The network of intelligent cameras 110 may also issue other information associated with the image, such as location of the camera, time of the image, weather conditions (e.g., to aid in identifying snow covered license plates), etc.

The enforcement computing device 120 may also receive payment confirmation from a payment vendor 140. The payment vendor 140 may be a third party payment platform, or may be implemented as part of the camera parking enforcement system. The payment vendor 140 may issue a payment confirmation 142 that can be implemented by the enforcement computing device 120 to determine whether the vehicle may have violated one or more policy of the parking facility 101 (e.g., parking and/or charging at an EV charging station for longer than was paid for).

The enforcement computing device 120 may access a vehicle identification module or device 150. In an example, the vehicle identification module or device 150 may implement optical character recognition (OCR) or other techniques to scan information from the image(s) 112 received from the network of intelligent cameras 110 and identify the vehicle. For example, the vehicle identification module or device 150 may access motor vehicle registration records from a government or private database.

The enforcement computing device 120 determines whether a violation has occurred. For example, a violation may have occurred if the vehicle remained in the parking facility 101 for a longer time than was paid for, did not pay for parking, entered a designated area or zone (e.g., VIP or handicapped parking) without proper credentials.

In an example, if a violation occurred, the enforcement computing device 120 may issue a potential violation 122 to a filter module 160. The filter module 160 may be implemented as a computer algorithm and/or include human interaction. The filter module 160 may consider factors such as whether the vehicle license plate in the image 112 matches the registration information, if the image was distorted or improperly read by the OCR component, if the vehicle had an exception or other credential which allowed parking or EV charging station use at the parking facility, if a holiday exemption applies, etc. Any of a wide variety of factors may be considered to filter or screen the potential violation before issuing a Notice of Violation 162 to the vehicle owner 102.

In an example, the vehicle identification device may be configured to identify the vehicle by at least one of the following: license plate, vehicle make, vehicle body style, vehicle color.

In an example, the intelligent network of cameras 110 provides at least one of the following to the enforcement computing device for the vehicle: time of vehicle entry, time of vehicle exit, camera identification (ID), camera location.

In an example, the intelligent network of cameras 110 provides a direction of travel of the vehicle to the enforcement computing device.

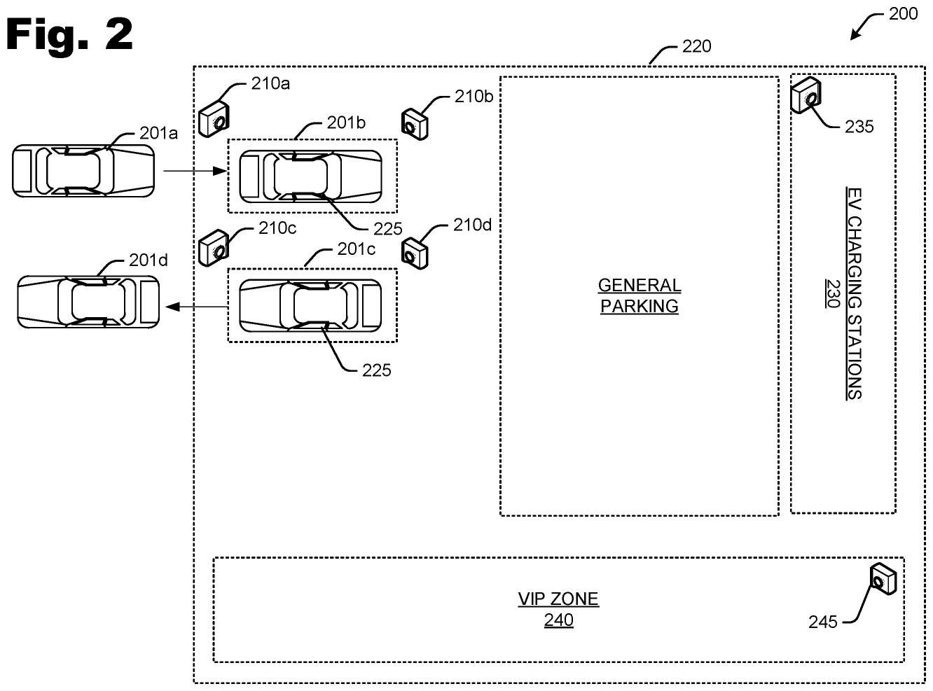

FIG. 2 illustrates example camera parking enforcement 200. In this example, an intelligent network of cameras may include one or more camera 210a-b to record a vehicle 201a-b entering a designated parking area 220, and one or more camera 210c-d to record the vehicle 201c-d leaving the designated parking area 220.

An enforcement computing device is configured to receive a first signal from the intelligent network of cameras indicating the vehicle 201a-b entering the designated parking area 220, and a second signal from the intelligent network of cameras indicating the vehicle 201c-d leaving the designated parking area 220.

In an example, the enforcement computing device determines a lot time based on the vehicle being in the designated parking area 220. The enforcement computing device compares the lot time to a payment confirmed by a payment processor. The enforcement computing device issues a notice of violation for the vehicle when the vehicle remains in the designated parking area for longer than an allowed time based on the payment confirmation.

In an example, the designated parking area may include one or more parking zones. For example, the designated parking area 220 may include parking and/or EV charging stations 230. A separate camera and/or network of cameras 235 may be provided for the parking and/or EV charging stations 230 to monitor vehicles coming in and leaving this zone. Other zones (e.g., “premium” zone 240) may also be provided, such as but not limited to, zones that are close to the building, zones that are all or partly shaded, handicap parking zones, etc. The implementation of zones and associated network of intelligent cameras (e.g., 245) to monitor these zones, enables the enforcement described herein to be tailored for specific parking areas, allow enforcement of handicap parking, and enable tiered charges/rates for parking in various zones.

In an example, the lot time includes a buffer time so that the vehicle can enter and exit the designated parking area without requiring payment. The buffer time may be provided to account for a full lot (e.g., enabling the vehicle sufficient time to leave the parking facility without incurring a violation for non-payment), pick-up and/or drop-off (e.g., at a hospital or restaurant), or any number of other reasons as determined by the owner of the designated parking area. The buffer time may be configurable by an owner of the designated parking area.

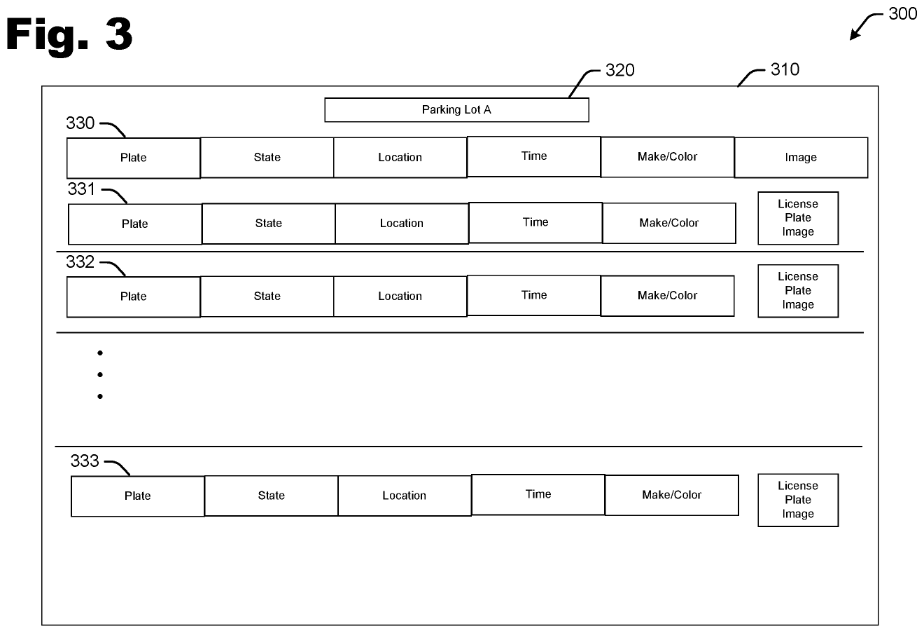

FIG. 3 shows an example user interface 300 for example camera parking enforcement. In an example, an end-user may access the user interface 300 for one or more parking area. The user interface 300 may render output as display 310 for the end-user. Any suitable output may be rendered. In the example shown in FIG. 3, the user interface 300 enables the end-user to sort and select from multiple parking areas, parking zones, spaces within parking zones, etc. In the illustration shown in FIG. 3, the end-user has selected “Parking Lot A” 320 and the user interface 300 returns rows 330-333 including violations for that parking area.

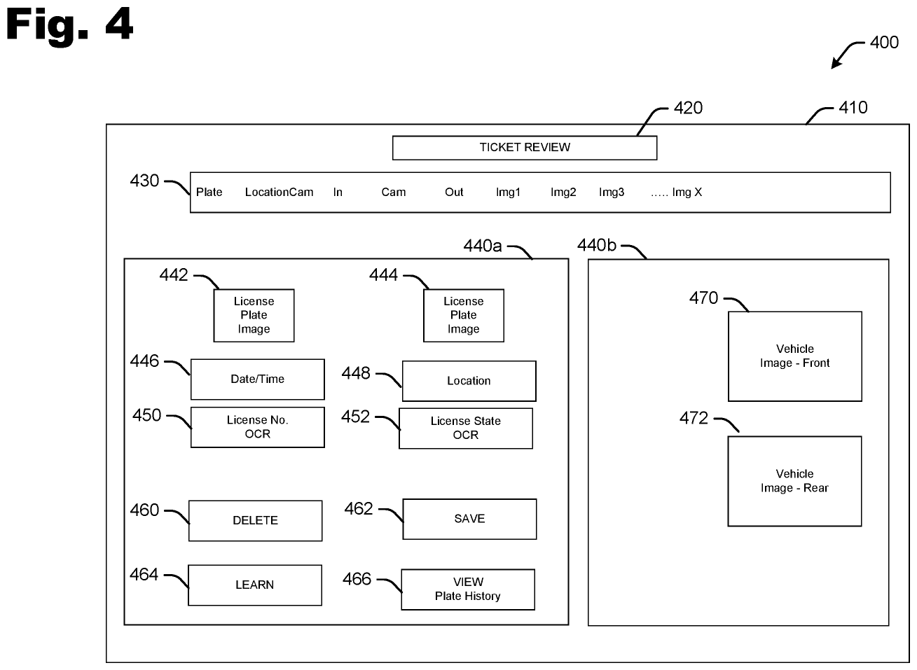

Examples of information may include a license plate number and state, location (e.g., parking space number, zone, etc.), time of violation, make/color and/or other information about the vehicle and an image of the license plate. Other information/images may also be rendered for the end-user so that the end-user can find the violations or potential violations for review. Upon making a selection, the user-interface 300 may render more detailed information for the selected violation, e.g., as illustrated by FIG. 4.

FIG. 4 is an example user interface 400 to review/filter violations for camera parking enforcement. In an example, the user interface 400 renders output as display 410 for the end-user to view more detailed information about a particular violation 420. Any suitable information may be rendered as output. In the example shown in FIG. 4, the user interface 400 renders a summary 430 of the violation, and more detailed information, e.g., in windows 440a, 440b. In the illustration of FIG. 4, window 440a displays a front view of the license plate image 442 and a rear view of the license plate image 444, a date/time 446 of the violation, location 448 of the violation, an OCR version 450 of the license plate number, and an OCR version 452 of the license plate state.

The user interface 400 may also enable user input, e.g., via input buttons 460, 462, 464, and 466. Example operations may include, but are not limited to, deleting an entry, saving an entry, learning (e.g., for future OCR corrections), and viewing a violation history associated with the license plate in question.

Window 440b may include images of the vehicle. For example, in the illustration in FIG. 4, images may include an image of the front of the vehicle 470 and an image of the rear of the vehicle 472. Still other images may be included (e.g., a side or profile view, images of the parking area or zone where the image was captured, etc.

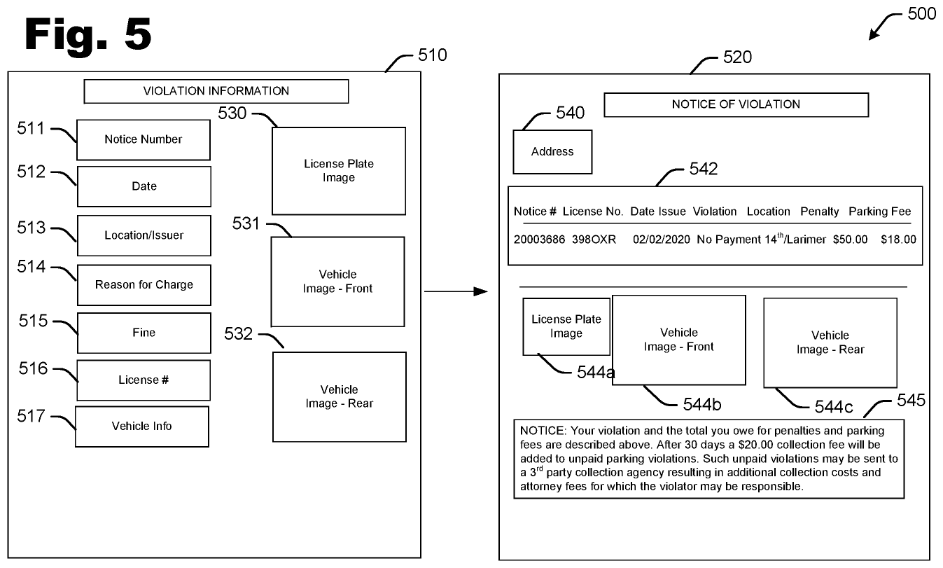

FIG. 5 is an example user interface 500 to generate violations for camera parking enforcement. In an example, the user interface 500 renders violation information 510 into a Notice of Violation 520 for a particular violation. Any suitable information may be rendered as output for the Notice of Violation 520 based on the violation information 510. In the example shown in FIG. 5, violation information 510 may include a Notice Number 511 (e.g., for internal tracking), Date of Violation 512, Location (e.g., parking lot) and/or Issuer (e.g., parking lot owner) of the violation 513, reason for the charge 514 (e.g., unauthorized zone parking; nonpayment; over time), the fine amount 515, license plate information 516, and vehicle information 517 (e.g., for confirmation.

Images of the vehicle may also be provided as part of the violation information. Images may serve to filter violations. For example, OCR versions of a license plate which do not match the images may be discarded. Likewise, images of a vehicle which do not match motor vehicle records may be discarded. In an example, only verified vehicle information is used to generate a Notice of Violation 520. Examples of images which may be provided may include, but are not limited to, license plate image 530, front of vehicle image 531, and rear of vehicle image 532.

The Notice of Violation 520 may include any suitable information. In the illustration shown in FIG. 5, the Notice of Violation includes an address 540 (e.g., based on motor vehicle registration) to send the violation to the vehicle owner, information 542 about the violation, and verification images 544a-c, and a notice about the violation 545.

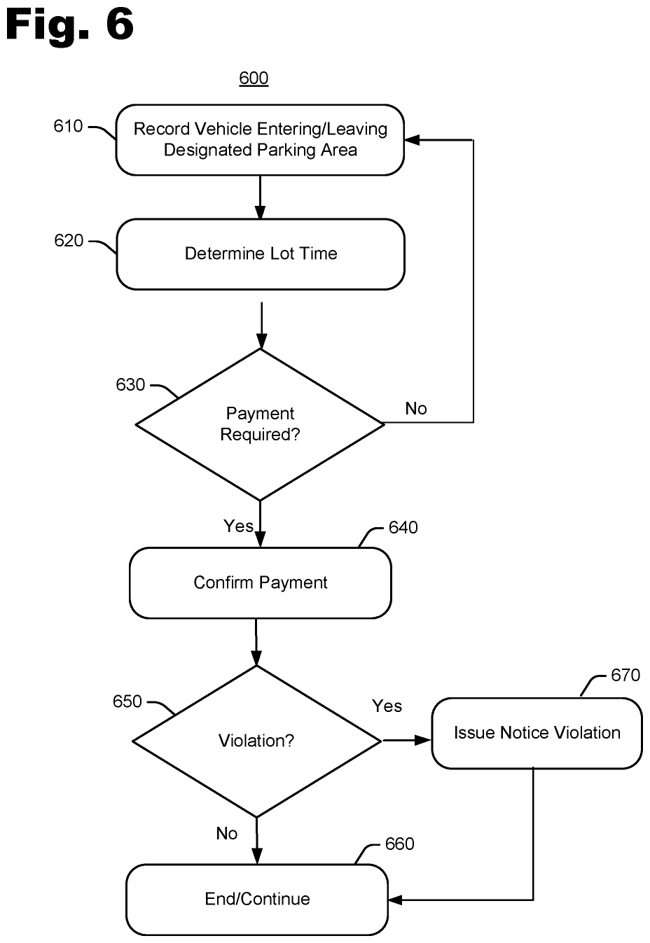

FIG. 6 is a flow diagram illustrating example operations 600 for camera parking enforcement. The operations shown and described herein are provided to illustrate example implementations. The operations are not limited to the ordering shown. Still other operations may also be implemented.

In example operation 610, an intelligent network of cameras records a vehicle entering/exiting a designated parking area. For example, an enforcement computing device may receive a first signal from the intelligent network of cameras indicating the vehicle entering the designated parking area, and the enforcement computing device may receive a second signal from the intelligent network of cameras indicating the vehicle leaving the designated parking area.

In example operation 620, the enforcement computing device determines a lot time based on the vehicle being in the designated parking area, e.g., based on entry and exit information received from the network of intelligent cameras.

In example operation 630, a determination is made whether payment is required. For example, no payment may be required if the vehicle exits within a buffer time. The buffer time may be preconfigured and/or configurable by an end-user. More than one buffer time may be provided (e.g., a buffer time for the parking lot, another buffer time for a parking and/or EV charging zone, another buffer time for a premium or VIP zone, etc.).

If payment is required, then the enforcement computing device may receive confirmation from a payment processor in example operation 640. If payment cannot be confirmed, or if the vehicle remained longer than was paid for, a determination may be made in example operation 650 whether to issue a Notice of Violation. If no violation occurred, then operations end and/or continue (e.g., for other vehicles) in example operation 660. Otherwise, a Notice of Violation is issued in operation 670. For example, a notice of violation may be issued for the vehicle when the vehicle remains in the designated parking area for longer than an allowed time.

Still other operations may be implemented. For example, operations may include identifying the vehicle by at least one of the following: license plate, vehicle make, vehicle body style, vehicle color. The intelligent network of cameras may provide at least one of the following to the enforcement computing device for the vehicle: time of vehicle entry, time of vehicle exit, camera identification (ID), camera location.

Further operations may include analyzing an image of at least a portion of the vehicle and/or an image of at least a portion of a license plate of the vehicle to the enforcement computing device.

Further operations may also include determining a direction of travel of the vehicle to the enforcement computing device.

Further operations may also include filtering potential violations to make a final determination whether the vehicle is in violation of parking rules.

Further operations may include enforcing parking in one or more zone within a parking area without any user interaction with onsite payment devices. For example, the user may enter a parking lot (having prepaid for a parking space) and park in a designated VIP parking zone, exit the vehicle (e.g., during a sporting event), and return to the vehicle and leave the parking lot without having to enter a space number or make any form of payment at a parking meter or attendant. It is noted that such a feature may be considered safer, as people are not required to stand in a parking lot and handle money or credit cards/wallets/purses to pay for parking. The payment can be handled safely on their mobile device at the parking lot from within their vehicle and/or prior to arriving at the parking facility.

It is noted that the examples shown and described are provided for purposes of illustration and are not intended to be limiting. Still other examples are also contemplated.

1. A system for camera parking enforcement, comprising:
an intelligent network of cameras including at least one camera to record a vehicle entering a designated parking area, and at least one camera to record the vehicle leaving the designated parking area;
an enforcement computing device configured to receive a first signal from the intelligent network of cameras indicating the vehicle entering the designated parking area, and a second signal from the intelligent network of cameras indicating the vehicle leaving the designated parking area, and the enforcement computing device configured to receive a third signal from at least one payment processor;
wherein the enforcement computing device determines a lot time based on the vehicle being in the designated parking area, and the enforcement computing device compares the lot time to a payment confirmed by the at least one payment processor;
wherein the enforcement computing device issues a notice of violation for the vehicle when the vehicle remains in the designated parking area for longer than an allowed time based on the payment confirmed by the at least one payment processor.

2. The system of claim 1, wherein the designated parking area includes at least one EV charging station for the vehicle.

3. The system of claim 1, wherein the lot time includes a buffer time so that the vehicle can enter and exit the designated parking area without requiring payment.

4. The system of claim 3, wherein the buffer time is configurable by an owner of the designated parking area.

5. The system of claim 3, wherein the buffer time is provided to account for a full lot.

6. The system of claim 3, wherein the buffer time is provided for pick-up and drop-off.

7. The system of claim 1, further comprising a vehicle identification device configured to identify the vehicle by at least one of the following: license plate, vehicle make, vehicle body style, vehicle color.

8. The system of claim 1, wherein the intelligent network of cameras provides at least one of the following to the enforcement computing device for the vehicle: time of vehicle entry, time of vehicle exit, camera identification (ID), camera location.

9. The system of claim 1, wherein the intelligent network of cameras provides an image of at least a portion of the vehicle to the enforcement computing device.

10. The system of claim 1, wherein the intelligent network of cameras provides an image of at least a portion of a license plate of the vehicle to the enforcement computing device.

11. The system of claim 1, wherein the intelligent network of cameras provides a direction of travel of the vehicle to the enforcement computing device.

12. The system of claim 1, further comprising a filtering module configured for making a final determination whether the vehicle is in violation of parking rules.

13. A method of camera parking enforcement, comprising:
recording, by an intelligent network of cameras, a vehicle entering a designated parking area, and the vehicle leaving the designated parking area;
receiving, by an enforcement computing device, a first signal from the intelligent network of cameras indicating the vehicle entering the designated parking area;
receiving, by the enforcement computing device, a second signal from the intelligent network of cameras indicating the vehicle leaving the designated parking area;
receiving, by the enforcement computing device, a third signal from at least one payment processor;
determining, by the enforcement computing device, a lot time based on the vehicle being in the designated parking area;
comparing, by the enforcement computing device, the lot time to a payment confirmed by the at least one payment processor;
issuing, by the enforcement computing device, a notice of violation for the vehicle when the vehicle remains in the designated parking area for longer than an allowed time based on the payment confirmed by the at least one payment processor.

14. The method of claim 13, further comprising providing a buffer time so that the vehicle can enter and exit the designated parking area without requiring payment.

15. The method of claim 14, further comprising configuring the buffer time.

16. The method of claim 13, further comprising identifying the vehicle by at least one of the following: license plate, vehicle make, vehicle body style, vehicle color.

17. The method of claim 13, wherein the intelligent network of cameras provides at least one of the following to the enforcement computing device for the vehicle: time of vehicle entry, time of vehicle exit, camera identification (ID), camera location.

18. The method of claim 13, further comprising analyzing an image of at least a portion of the vehicle and/or an image of at least a portion of a license plate of the vehicle to the enforcement computing device.

19. The method of claim 13, further comprising enforcing parking in one or more zone within a parking area without any user interaction with onsite payment devices.

20. The method of claim 13, further comprising filtering potential violations to make a final determination whether the vehicle is in violation of parking rules.
